(19) United States
(12) Patent Application Publication
(10) Pub. No.: US 2018/0254131 A1
(43) Pub. Date: Sep. 6, 2018

(54) TRANSFORMER, COIL FORMER FOR SAID TRANSFORMER, AND METHOD FOR PRODUCING A COIL FORMER

(71) Applicant: Karlsruher Institut fuer Technologie, Karlsruhe (DE)

(72) Inventor: Sebastian Hellmann, Karlsruhe (DE)

(21) Appl. No.: 15/754,298

(22) PCT Filed: Aug. 20, 2016
(86) PCT No.: PCT/EP2016/001412

§ 371 Date: Feb. 22, 2018

(30) Foreign Application Priority Data
Aug. 27, 2015 (DE) 102015114208.2

(51) Int. Cl. H01F 5/02; H01F 36/00; H01F 41/04; H01F 41/098; H01F 6/06; H01F 27/32

(52) U.S. Cl. CPC H01F 5/02; H01F 36/00; H01F 27/324; H01F 41/098; H01F 6/06; H01F 41/048

(57) ABSTRACT

A winding body for a superconductive secondary winding for a superconductive current-limiting transformer includes a plurality of depressions and casing portions distributed around a circumference in the longitudinal direction; and grooves in the casing portions in the circumferential direction. The winding body is configured such that a superconductive conductor of the secondary winding can be wound around the winding body in a normal state such that the conductor rests against the casing portions and is received in the grooves. A gap can be formed between the conductor and each of the depressions.

### CROSS REFERENCE TO RELATED APPLICATIONS

This application is a U.S. National Stage Application under 35 U.S.C. § 371 of International Application No. PCT/EP2016/001412 filed on Aug. 20, 2016, and claims benefit to German Patent Application No. DE 10 2015 114 208.2 filed on Aug. 27, 2015. The International Application was published in German on Mar. 2, 2017 as WO 2017/032451 A1 under PCT Article 21(2).

### FIELD

The invention relates to a superconductive current-limiting transformer, to a winding body for such a transformer, and to a method for producing such a winding body.

### BACKGROUND

Superconductive current-limiting transformers are known from the prior art, in which such a transformer can comprise a normally conductive or a superconductive primary winding, which is wound around an iron transformer core. A superconductive secondary winding is assigned to the primary winding and is wound on a winding body so as to uniformly rest thereagainst in order to secure the superconductive wires more effectively. The two windings are coaxial. In order to cool the superconductive winding(s), a cooling bath comprising liquid nitrogen is provided in a cryostat arranged inside the transformer.

In this case, the principle of the superconductive current-limiting transformer is based on targeted heating of the superconductive material in the winding(s), for example in the event of the mains short-circuiting. Upon heating, the electrical resistance of the superconductor significantly increases and leads to a direct reduction in the short circuit current flowing. In the event of a short circuit, the currents flowing in the transformer windings are several times greater than during normal operation, thus also significantly increasing the stray field generated by the currents. The magnetic stray field causes a force to be applied to the two windings of the transformer, the direction of which faces away from the leakage air gap.

In addition to the increasing application of force to the superconductor and the simultaneous heating thereof, the conductors of the superconductive secondary winding expand. This expansion takes place in the radial direction due to the type of winding, such that, in the event of a short circuit, the superconductive winding bulges radially outwards in places and can be mechanically damaged. This leads to damage to the superconductive winding and requires complex repair or even expensive replacement.

DE 20 2013 100 358 U1 describes an inductive component comprising a core consisting of a plurality of limb elements, in which a current-carrying winding is stabilized inside a core using a film.

DE 10 2013 216 210 A1 discloses winding bodies for a stator of an electric motor that is arranged in the end portion of the stator, which bodies can be inserted into one another. The winding bodies comprise guide elements for guiding the wires. For this purpose, the guide elements comprise portions provided as groove-shaped guide portions. A type of trough is formed, which receives an entire winding and holds it in shape.

### SUMMARY

In an embodiment, the present invention provides a winding body for a superconductive secondary winding for a superconductive current-limiting transformer, the winding body having a hollow-cylindrical basic shape. The winding body includes a plurality of depressions and casing portions distributed around a circumference in a longitudinal direction; and grooves in the casing portions in the circumferential direction. The winding body is configured such that a superconductive conductor of the secondary winding can be wound around the winding body in a normal state such that the conductor rests against the casing portions and is received in the grooves. A gap can be formed between the conductor and each of the depressions.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a half-section through a transformer according to an embodiment of the invention;

FIG. 2 is a perspective view of a winding body according to an embodiment of the invention;

FIG. 3 is a detailed view of an edge region of the winding body according to an embodiment of the invention;

FIG. 4 is a detailed view of the cross section of the winding body according to an embodiment of the invention;

FIG. 5 is a perspective view of a multiple-part winding body according to an embodiment of the invention that has not yet been fully assembled;

FIG. 6 is a detailed view of the detail C in FIG. 5;

FIG. 7 is a side view of the multiple-part winding body;

FIG. 8 is a perspective view of a segment of the multiple-part winding body;

FIG. 9 is a plan view of a segment;

FIG. 10 is a schematic perspective view; and

FIG. 11 is a schematic plan view of a spacer according to an embodiment of the invention.

### DETAILED DESCRIPTION

Stabilizing solutions from the above-mentioned prior art cannot sufficiently stabilize a superconductive winding, since superconductive wires can jump out of the grooves in the event of a short circuit. Embodiments of the present invention provide improved winding bodies that prevent the superconductive winding in a transformer from being destroyed in the event of current limitation.

Embodiments of the present invention provide winding bodies for a superconductive current-limiting transformer, superconductive current-limiting transformers that have a simple structure and that can be used multiple times to limit current, and methods for simple production of winding bodies for superconductive current-limiting transformers.

According to an embodiment, a winding body is provided for a superconductive secondary winding for a superconductive current-limiting transformer, the winding body having a hollow-cylindrical basic shape. According to the embodiment of the invention, the winding body comprises a plurality of depressions and casing portions distributed around its circumference in the longitudinal direction, and grooves being made in the casing portions in the circumferential direction. In this case, a superconductive conductor of the secondary winding can be wound around the winding body in a normal state such that the conductor can rest against the casing portions and can be received in the grooves, and a gap can be formed between the conductor and the depressions or each depression.

In the context of the invention, “normal state” can be understood to mean that the superconductive conductor is in the form of a strip-shaped superconductor, preferably in the form of a thin-film superconductor (e.g. a YBCO strip conductor), as produced, and, when cooled below its critical temperature Tc, is superconductive. The normal state has the same form as an unstressed, i.e. not expanded, conductor state. The conductor is in an “expanded state” when it is forced from a superconductive state into a normally conductive state by the high current density during a short circuit in the mains, the conductor heating up due to ohmic losses and expanding in accordance with its respective coefficients of expansion.

In this case, the casing portions and the depressions can alternate along the circumference of the winding body such that, in a preferred embodiment, the outer lateral surface of the winding body forms a wave-like structure in cross section.

In the event of a fault, if the superconductive conductor heats up and accordingly expands, the conductor can be pressed into the depressions by the field force applied. In an expanded state of the conductor material (“expanded conductor”), the conductor can rest fully against the winding body. The invention thus prevents the uncontrolled radial outward bulging of the superconductive winding in the event of a fault, and protects the superconductive winding against mechanical damage. Above all, this is made possible by the vertical depressions along the circumference of the body of the winding body, into which the superconductive conductor, which can be wound around the winding body, can simply expand.

Grooves can be made in the casing portions in the circumferential direction, i.e. along the circumference, in which grooves the superconductive conductor of the secondary winding is received such that the gap is formed between the conductor and the depression. The grooves make it possible to wind a conductor in a guided manner.

Furthermore, embodiments of the invention can provide depressions including a curved bottom or a curved base. In this case, a radius of the bottom can correspond to a radius that is larger than a minimum bend radius of the superconductive conductor. In this respect, the dimensions of the depressions, i.e. including the base or bottom thereof, curvature and spacing, should therefore be greater than the minimum bend radius of the conductor. In the invention, the geometric radii of the contact surface between the winding and the winding body can advantageously be of such a size that it is not possible to fall below the minimum permissible bend radii of the superconductive material either during normal operation, i.e. when the conductor is unstressed, or in the event of a short circuit, i.e. when the conductor is expanded. As a result, a winding body can be provided on which a conductor can be drawn so as to be protected against mechanical damage in the event of a fault.

According to embodiments of the invention, the dimensions can such that they correlate with an average coefficient of thermal expansion a of the superconductive material. Due to the generally anisotropic coefficient of thermal expansion of the high-temperature superconductor to be used here, an average degree of expansion or the highest known degree of expansion can be used as the reference point for the maximum degree of expansion of the superconductive material.

According to embodiments of the invention, the grooves can be arranged helically around the winding body in the longitudinal orientation of the winding body. As a result, the coil can be wound in a guided manner without conductors lying on top of one another inside a single layer or moving uncontrollably during a current-limiting process.

The number and depth of the depressions is dependent on the maximum expansion or the possible bend radii (for example according to the manufacturer's specifications) of the superconductive material used in each case, and has to be adapted thereto. In the example of a superconductor in the form of a strip and comprising a stainless steel carrier foil (Cr-Ni steel) comprising at least one layer of a 1-5 μm-thick YBCO layer and a copper layer (cover layer) forming thereon, a depression having a depth of from 2 to 8 mm, preferably from 4 to 5 mm and a width of from 80 to 120 mm was proposed, from 2 to 50, preferably from 8 to 30, more preferably from 15 to 20 depressions being arranged in the circumference of the winding body and the casing potions that are between two depressions in each case and are provided with grooves are preferably between 30 and 100 mm wide. The depressions and casing portions preferably each have the same dimensions and/or are arranged at equal spacings from one another over the circumference of the winding body. In this case, the superconductor in the form of a strip has a laminate thickness of between 50 and 500 μm, preferably of from 100 to 400 μm, more preferably between 200 and 300 μm (upper and lower limits are to be considered to be independent of one another). A successful test was carried out using this structure comprising strip superconductors having a laminate thickness of 350 μm at 18 depressions having a depth of 4 mm and a width of 100 mm, and casing portions therebetween having a width of 20 mm, two strip superconductors having been arranged one above the other in each case.

According to embodiments of the invention, the winding body can also consist of glass-fiber reinforced plastics material. For use inside cryogenic fluids, this material is particularly stable, robust and not electrically conductive. In an alternative embodiment of the invention, other materials that are similarly suitable can also be used. Therefore, unreinforced plastics materials can be used, which can be cast or injected.

According to embodiments of the invention, the winding body can be integral or in multiple parts. Multiple variants are therefore possible:

An integral winding body produced from a whole piece and a winding body that can be assembled from of a plurality of parts.

According to embodiments of the invention, the multiple-part winding body can be made up of a plurality of segments that are arranged in the shape of a spiral around a support tube. In an alternative embodiment of the invention, the segments can also be assembled in the shape of a ring, so as to produce a stack in which a layer of segments and an annular spacer alternate. The arrangement of the plurality of segments forms a carrier body for the superconductive strip that is to be wound on the subsequent winding body. The increase in the number of spirals and the number of segments required for one revolution or turn or a circle are predetermined by the geometry of the segments or by their dimensions.

The support tube can hold the spiral or stack of segments or can only be used during production for stabilization purposes. Furthermore, the internal support tube stabilizes the overall structure of the winding in the radial direction in order to withstand the application of magnetic forces in the event of large currents occurring during a short circuit. In this case, the winding body can be scaled in this respect, since, as a result of expansion in the longitudinal direction, additional segments can be easily extended in the shape of a spiral around a, for example longer, support tube of the winding body in a simple manner. Therefore, a shorter winding body can also be produced or simply adapted to the relevant parameters in the cryostat. The individual components of the resultant overall structure can be produced both simply and cost-effectively.

Each segment can have an elongate, intrinsically curved shape that may be in the shape of a wave. In this case, each segment can comprise connecting elements on its end faces, it being possible for a first connecting element of a first segment to correspond to a second connecting element of a subsequent connecting element. Therefore, pin-and-hole connecting elements are possible: the first connecting element can be a pin having a rectangular or round cross section. The second connecting element can be a blind hole or mortice, the dimensions of which accordingly correspond to those of the first connecting element. Depending on the use, it may also make sense to use other connecting elements. The pin-and-hole system described can preferably be used, since it has a good degree of mechanical strength. On the side of the contour thereof that faces outwards and away from the winding body, the segments have radii which do not allow the superconductive winding to be mechanically damaged due to the minimum bend radius not being met. The segments can be produced in large numbers from a suitable plastics material by using conventional production methods such as injection molding, pultrusion or extrusion together with brief additional post-processing.

Furthermore, spacers can be arranged between adjacent segments in the longitudinal direction of the winding body. The spacers can be circular-arc-shaped and can be arranged in the shape of a spiral or ring, in accordance with the arrangement of the segments. According to embodiments of the invention, the length of the spacers may be greater than or equal to the dimensions of the segments in the circumferential direction of the winding body. The spacers are used to hold the superconductive wire in position and to electrically insulate the windings of the superconductive coil from one another. For this purpose, depending on the winding structure required, the spacers can have different thicknesses. Like in the segments, holes are also provided in the spacers, which holes are congruent with the holes in the segments when the winding body is formed. The spacers can be designed such that they can hold the individual superconductive wires or windings in a specific position and at the same time allow for sufficient cooling. This happens as a result of the spacers having a shape which, when viewed around the circumference of the arrangement, allows them to protrude between the segments of the structure only in part. The superconductive wires are fixed in position only at these positions, all other portions along the superconductive winding are recessed in the spacer and are therefore available for the unimpeded circulation of the coolant. The spacers can be produced cost-effectively, for example by punching, in circular elements of any size.

In this embodiment of the invention, the individual segments can also be provided with grooves in order to securely hold the winding wires to be wound. Due to their design, the ends of the segments allow them to support one another and to supplement one another so as to form a frictional bond when they are stressed from the outside by the superconductor to be carried. The internal support tube is used to further increase the mechanical strength of the winding structure, but is not necessarily required. The support tube can be a pipe having closed side walls and can be made of plastics material or a glass-fiber reinforced plastics material (GFRP).

A superconductive current-limiting transformer according to embodiments of the invention preferably comprises a normally conductive primary winding which is arranged around the main limb of a closed iron core or is alternatively wound or formed around the limb of an iron core. A superconductive secondary winding is coaxially arranged inside the primary winding, the superconductive secondary winding being wound on a winding body. The winding body according to the invention is described above. In this case, a superconductive conductor of the secondary winding is wound around the winding body in a normal state such that the conductor rests against the casing portions and a gap is formed between the conductor and each of the depressions.

According to embodiments of the invention, the transformer can comprise a cryostat for cooling the secondary winding, in which cryostat the secondary winding is placed in a cooling bath. In this case, the cryostat or the wall thereof can space the secondary winding apart from the primary winding and therefore form a leakage air gap. The relevant magnetic field forms in this leakage air gap, while the geometry or the spacing between the windings substantially influences the short-circuit voltage of the transformer.

High-temperature superconductors can preferably be used. Various liquefied cold gases can be used as the cryogenic fluid, for example nitrogen, or, in the case of closed bath cryostats, i.e. bath cryostats isolated on all sides, substantially colder liquid helium. However, liquid nitrogen is most commonly used for cost reasons.

Methods according to embodiments of the invention can be used to produce a winding body for a superconductive current-limiting transformer. In a first step, a circular-cylindrical or hollow-cylindrical GFRP blank is provided. After this, a plurality of depressions are milled out of the lateral surface of the blank in the longitudinal direction, which depressions are arranged so as to be equidistant around the circumference of the blank. As a result, a wave-like structure can be formed in the cross section of the blank. After this, in a further step, grooves are milled out along the circumference of the blank on the remaining lateral surface portions in order to be able to receive the superconductive conductor in the grooves.

In this case, the dimensions to be selected are dependent on the dimensions of the superconductive wires that are intended to be wound around the winding body. The two last-mentioned steps can also be carried out in the reverse order, depending on the material to be machined.

In another possible step, the blank can be moved in the longitudinal direction at a specific advancement speed when making the grooves, so that the grooves are arranged in the shape of a spiral when the winding body is finished. A winding can therefore be subsequently threaded both easily and simply.

In a method for producing a multiple-part winding body for a superconductive current-limiting transformer, the circular-cylindrical support tube and the required number of segments and spacers are provided in a first step. The individual segments are arranged one behind the other by means of their connecting elements. The segments are arranged in the shape of a spiral around the support tube, a preceding segment and a subsequent segment being connected and a spiral being formed, the spacer being placed between one winding of the spiral and an adjacent spiral winding.

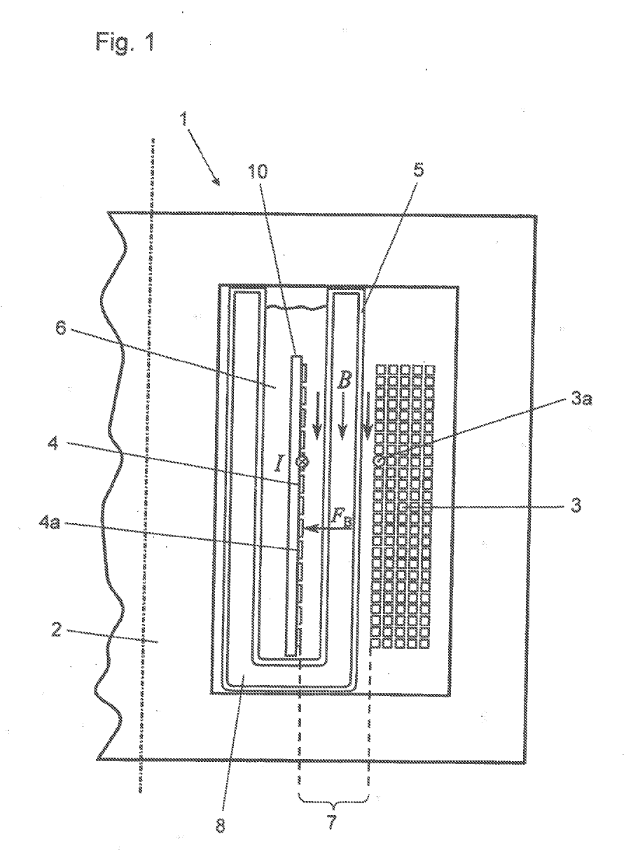

In FIG. 1, a superconductive current-limiting transformer 1 comprises an iron core 2 which surrounds a normally conductive primary winding 3. A lead 3a is denoted by a symbol for the direction of the electrical current in FIG. 1, the current in the primary winding 3 is directed such that it exits through the image plane (for an alternating current, this state represents the directions of only a half-wave; the directions reverse with the polarity).

A secondary winding 4 is arranged coaxially inside the primary winding 3, the leads 4a of which (cf. reference numeral 15 in FIG. 4) consist of a superconductive material (e.g. comprising an ReBCO (=rare earth barium copper oxide) thin-film strip conductor or BSCO (=bismuth strontium calcium copper oxide) strip conductor). In this case, the secondary winding 4 is made up of one winding layer consisting of the superconductive conductor 4a, through which current flows in FIG. 1 such that the current enters through the image place (or exits therethrough, depending on the polarity).

In order for the material of the secondary winding 4 to also be made superconductive, a cryostat 5 comprising a cooling bath 6 is provided, which cryostat surrounds the secondary winding 4 on three sides in the shape of a U in longitudinal section, the entire secondary winding being surrounded by cryogenic cooling fluid (e.g. liquid nitrogen) in the cooling bath and therefore fluid that is less cryogenic being required. The cryostat 5 is made of glass-fiber reinforced plastics material and comprises an evacuated inner chamber 8 which is used to insulate the cooling bath 6.

The secondary winding 4 and the primary winding 3 are spaced apart from one another in the radial direction so that they are not directly adjacent but a leakage air gap 7 is formed. A magnetic field B is formed in this leakage air gap 7. The leakage air gap forms in the transformer between the primary and secondary winding. In this case, the dimensions are essentially comparable with the dimensions of a conventional transformer.

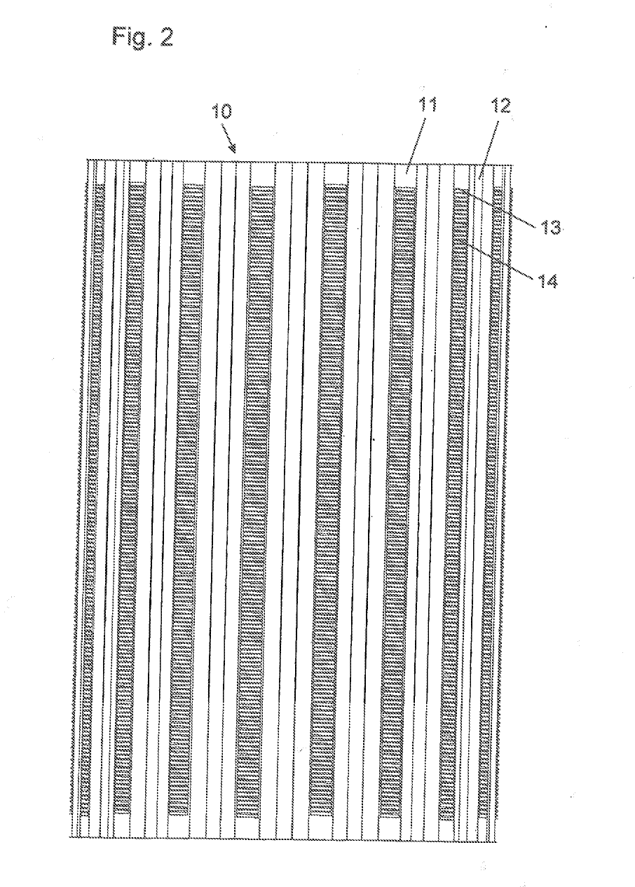

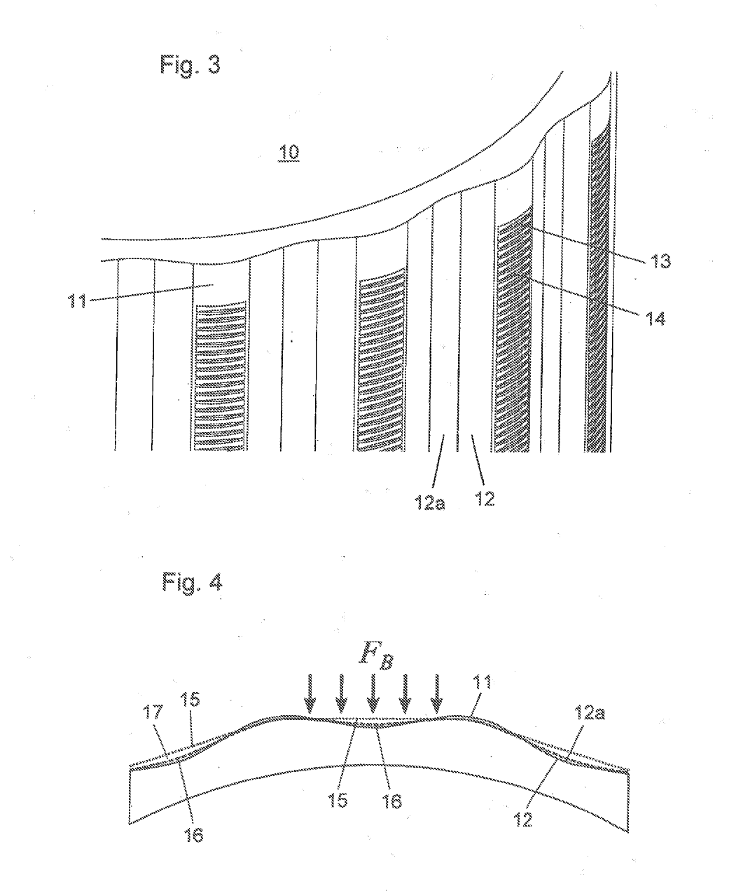

The secondary winding 4 is furthermore wound on a winding body 10, which is made of a non-conductive material such as glass-fiber reinforced plastics material, in order to form a stable coil. In FIGS. 2 to 4, the winding body 10 has a substantially circular-cylindrical shape. The winding body 10, depressions 12 and remaining casing portions 11, which are arranged so as to alternate, can be seen along the circumference of said winding body. Said components alternate so as to form a wave-like structure along the circumference in cross section, as can be seen in FIG. 3 and FIG. 4. Grooves 14 are made in the circumferential direction in the casing portions 11. These grooves 14 are delimited by raised portions 13. In this case, the grooves 14 and raised portions 13 are of such a size that a superconductive conductor 15 of the secondary winding 4 can be held and uniformly wound around the winding body 10. The dimensions can be adapted to the conductor 15 in this case.

If the superconductive conductor 15 is received in the grooves 14, the conductor 15 is received in the casing portions 11 between the raised portions 13 and stretches over the depression 12, as shown in FIG. 4. As a result, a gap 17 is formed, which can approximately or at least receive the longitudinal expansion of the conductor 15 in the event of a short circuit. In this case, the depression 12 comprises a bottom 12a which is curved so as to have a predetermined curvature having a defined radius. This bottom forms a base of the depression. In this case, this radius is larger than a minimum bend radius of the superconductive conductor 15. It can therefore be ensured that, in the event of a short circuit, the superconductive conductor 15 in the form of an expanded conductor 16 can be fully received in the depressions 12 and does not easily break or get damaged in another way by the resultant bending.

In the event of a short circuit, the conductor 15 of the primary winding 4 expands and is subjected to the application of a force FB by the magnetic stray field B. In this case, the conductor in the form of an expanded conductor 16 is pressed into the depressions 12 in the winding body 10. This is shown in FIG. 4 by the additional conductor course of the expanded conductor 16 in comparison with the course of the unstressed conductor 15. This satisfies the requirements of the longitudinal thermal expansion of the conductor, as a result of which the conductor 15 does not radially bulge outwards, as may be the case in conventional winding body structures.

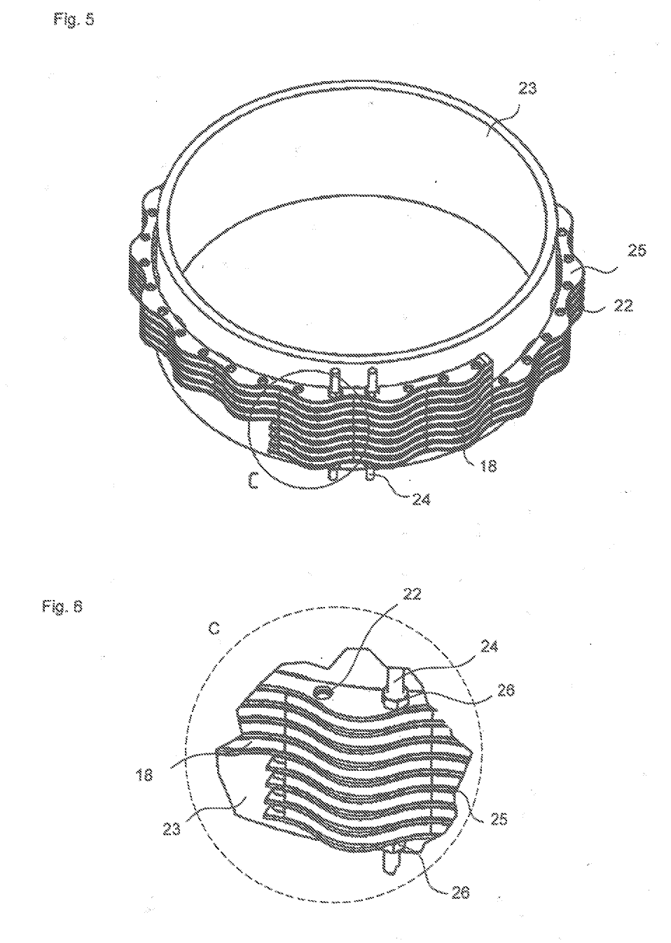

The winding body according to the variant shown in FIGS. 1 to 4 is integral. In another variant, the winding body, as shown in FIGS. 5 to 11, is in multiple parts and is composed of a plurality of individual segments 18.

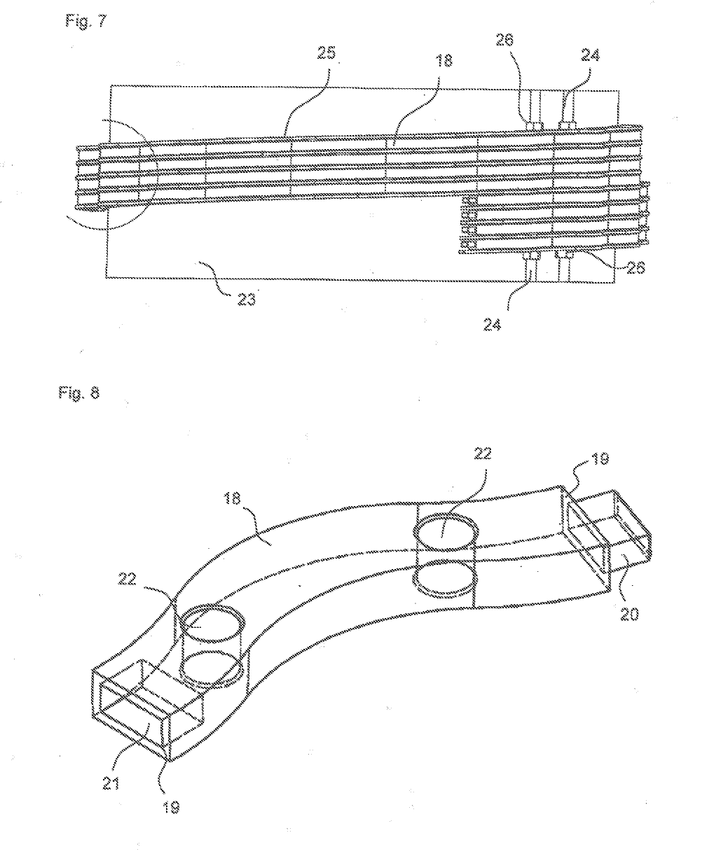

A plurality of individual segments 18 are arranged in the shape of a spiral around a support tube 23, as shown in FIG. 5 and FIG. 7, in order to form the winding body 10. In this case, the winding body can be scaled in this respect, since, as a result of the expansion in the longitudinal direction, additional segments 18 can be easily extended in the shape of a spiral around a, for example longer, support tube 23 of the winding body 10 in a simple manner. Therefore, a shorter winding body can also be produced or simply adapted to the respective parameters in the cryostat 5. The support tube 23 can be used to stabilize the segment spiral. The winding body 10 shown in FIG. 5 denotes a possible arrangement in which four superconductive wires or superconductive groups consisting of wires or strip conductors can be guided in parallel, in the form of a four-path spiral.

Detail C from FIG. 5, which is shown in an enlarged view in FIG. 6, shows the fastening of the winding body elements, segments 18 and spacers 25. The segments 18 and spacers 25 comprise holes 22. Fastening rods 24 are guided through two of these holes 22 and are fastened by nuts 26. Fastening rods 24 are threaded rods or the like, which are screwed using screw elements, for example the nuts 26. These can optionally be selected from a non-conductive or non-ferromagnetic material. The arrangement consisting of the segments 18 and the spacers 25 is secured in this way and effectively holds the winding 4 that is to be applied. The holes 22 are therefore used to receive the fastening rods 24, which press the entire arrangement together in the axial direction. The rods 24 can, for example, be formed as GFRP threaded rods, it theoretically even being possible for metal threaded rods to be used.

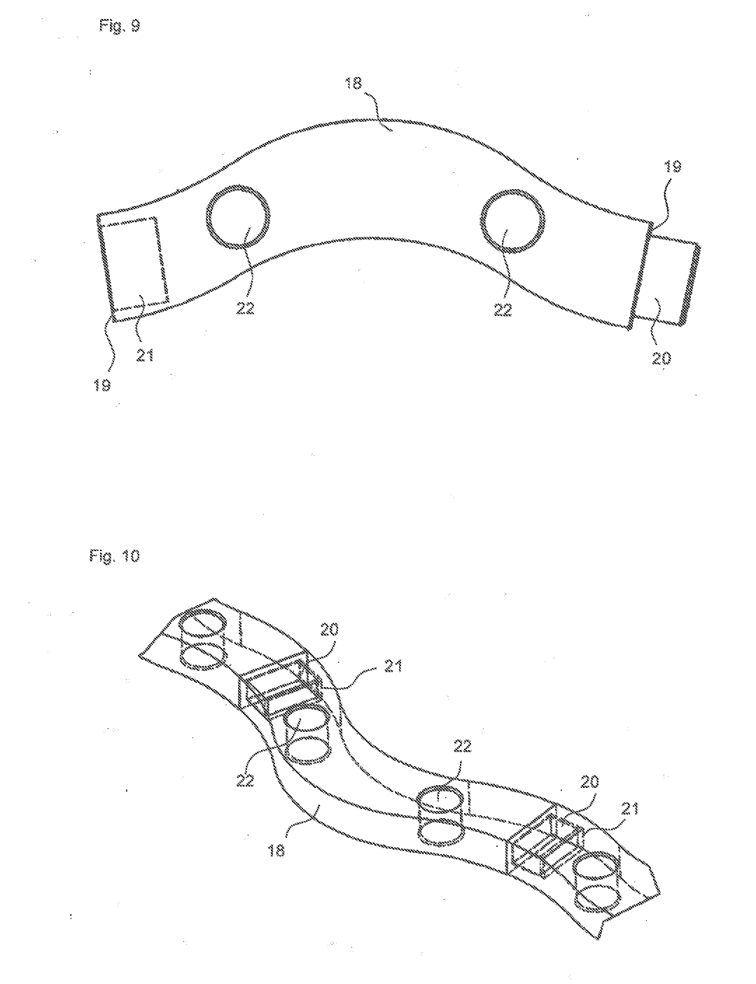

According to FIGS. 8 to 10, each segment 18 has a substantially elongate, intrinsically curved basic shape which corresponds to the form of a repeating wave shape, whereby, according to FIG. 9, the shape begins on the left at a minimum point of the wave-shape, and follows this shape, to the right, over the maximum point thereof and back to a minimum point.

The segment 18 comprises connecting elements 20 and 21 on its end faces 19. A first connecting element 20 is a pin 20 having a rectangular cross section, and a second connecting element 21 is shaped as a recess in the form of a blind hole that corresponds to the pin 20. The shape of the blind hole 21 copies that of the pin 20 such that the connecting elements 20, 21 of two adjacent segments 18 engage in one another.

FIG. 10 shows a segment 18 which is connected to two adjacent segments in this figure, it can be seen that each pin 20 correspondingly engages in a blind hole 21. In this case, the end faces 19 of the adjacent segments 18 rest against one another such that a continuous wave-shaped contour, around which superconductive material is to be subsequently wound, is formed.

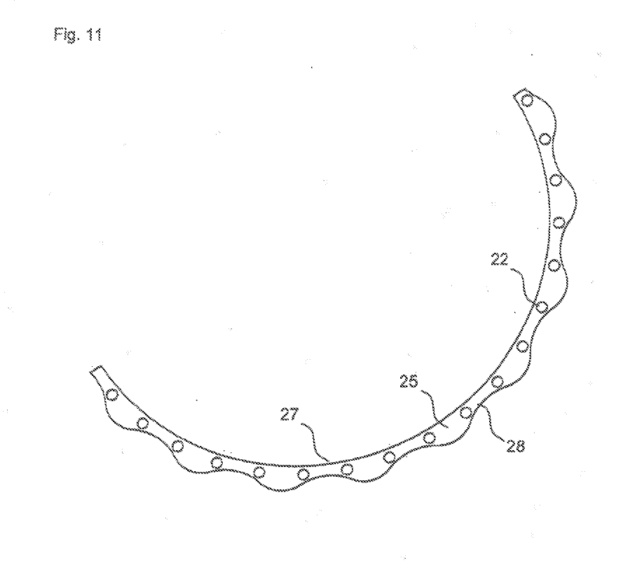

The spacers 25 are arranged between adjacent segments 18 in the longitudinal direction of the winding body 10. According to FIG. 11, such a spacer has the shape of a pitch circle or circular arc and copies the contours of the segments 18. An inner contour 27, which faces the support tube 23, is circular-arc-shaped in accordance with the circumferential bend of the support pipe 23. An outer contour 28 is wave-shaped, the wave-like shape being adapted to the contour that is formed by the segments 18 that are strung together. In this case, the length of the spacers 25 corresponds to several times the length of the segments 18, i.e. is greater than or equal to the dimensions of the segments 18 in the circumferential direction of the winding body 10. The spacers can, for example, be punched out of plastics films, and are therefore provided separately for each turn in the winding and have to be inserted between the individual segment arrangements in layers.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 transformer
2 iron core
3 primary winding
3a primary winding electrical conductor
4 secondary winding
4a secondary winding electrical conductor
5 cryostat
6 cooling bath
7 leakage air gap
8 evacuated inner chamber of the cryostat
10 winding body
11 casing portion
12 depression
12a bottom of the depression
13 raised portion or boundary
14 groove
15 unstressed conductor
16 expanded conductor
17 gap
18 segment
19 end face
20 connecting element (pin)
21 connecting element (hole)
22 holes
23 support tube
24 fastening rod
25 spacer
26 fastening nut
27 inner contour
28 outer contour

1. A winding body for a superconductive secondary winding for a superconductive current-limiting transformer, the winding body having a hollow-cylindrical basic shape, the winding body comprising:
a plurality of depressions and casing portions distributed around its a circumference in a longitudinal direction; and
grooves in the casing portions in the circumferential direction,
wherein the winding body is configured such that a superconductive conductor of the secondary winding can be wound around the winding body in a normal state such that the conductor rests against the casing portions and is received in the grooves, and
wherein a gap can be formed between the conductor and each of the depressions.

2. The winding body according to claim 1, wherein each depression comprises a bottom that is concavely curved with respect to a longitudinal axis of the winding body, wherein a radius of the bottom corresponds to a radius that is larger than a minimum bend radius of the superconductive conductor.

3. The winding body according to claim 1, wherein the grooves are arranged in the longitudinal direction so as to spiral around the winding body.

4. The winding body according to claim 1, wherein there is an even number of depressions, the number preferably being in a range of from 8 to 30.

5. The winding body according to claim 1, wherein the winding body is integral or in multiple parts.

6. The winding body according to claim 5, wherein the winding body is a multiple-part winding body and is made up of a plurality of segments that are arranged in the shape of a spiral around a support tube.

7. The winding body according to claim 6, wherein spacers are arranged between adjacent segments in the longitudinal direction of the winding body.

8. The winding body according to claim 6, wherein each segment has an elongate, curved shape in the shape of a wave, each segment comprising connecting elements on end faces, a first connecting element of a first segment corresponding to a second connecting element of a subsequent connecting element.

9. The winding body according to claim 7, wherein a length of the spacers is greater than or equal to dimensions of the segments in the circumferential direction of the winding body.

10. A superconductive current-limiting transformer comprising:
a normally conductive primary winding inserted in an iron core,
a superconductive secondary winding coaxially arranged in the iron core, the superconductive secondary winding being wound on a winding body,
wherein the winding body is a winding body according to claim 1,
wherein a superconductive conductor of the secondary winding is wound around the winding body in a normal state such that the conductor rests against the casing portions and a gap is formed between the conductor and each of the depressions.

11. The transformer according to claim 10, wherein, in order to cool the secondary winding, the transformer comprises a cryostat, in which the secondary winding is placed in a cooling bath, wherein the secondary winding is spaced apart from the primary winding forming a leakage air gap.

12. A method for producing an integral winding body for a superconductive current-limiting transformer, the method comprising:
providing a circular-cylindrical GFRP blank;
milling out a plurality of depressions from a lateral surface of the blank in the longitudinal direction and arranging the depressions so as to be equidistant around a circumference of the blank, thereby producing a wave-like structure in cross section of the blank; and
milling out grooves along the circumference of the blank on the remaining lateral surface portions.

13. The method according to claim 12, further comprising moving the blank in the longitudinal direction at a specific advancement speed when milling out the grooves, so that the grooves are arranged in the shape of a spiral when the winding body is finished.

14. A for producing a multiple-part winding body for a superconductive current-limiting transformer, the method comprising:
providing a circular-cylindrical support tube, a plurality of segments and spacers; and
arranging the segments in a shape of a spiral around the support tube, thereby connecting a subsequent segment to a preceding segment by placing a spacer between one winding of the spiral and an adjacent winding of the spi
